(19) United States
(12) Patent Application Publication
(10) Pub. No.: US 2003/0188931 A1
(43) Pub. Date: Oct. 9, 2003

(54) Brake mechanism for resilient wheel

(76) Inventors: Richard LaBrash, Salem, MO (US); Edward L. Arnell, Strafford, MO (US)

Correspondence Address: Thomas A. Polcyn, Thompson Coburn LLP, One US Bank Plaza, St. Louis, MO, 63101-9928, US

(21) Appl. No.: 10/429,397

(22) Filed: May 5, 2003

Related U.S. Application Data
(63) Continuation-in-part of application No. 09/798,765, filed on Mar. 2, 2001, now Pat. No. 6,575,271.

(51) Int. Cl. B62L 5/00

(52) U.S. Cl. 188/26; 188/18 A; 188/72.1; 188/152

(57) ABSTRACT

A wheel and brake system is provided for a vehicle having a wheel with an inner wheel, an outer wheel generally concentric with the inner wheel, and a plurality of resilient members connecting the inner and outer wheels together for resilient movement therebetween. The wheel and brake system comprises a brake mechanism having a rotor and a caliper. The rotor rotates with the inner wheel and the caliper is rotationally fixed in position relative to the resilient wheel. An actuation system causes first and second rotor-engaging surfaces of the caliper to move toward one another to squeeze the rotor therebetween and to thereby resist rotation of the inner wheel.

This application is a continuation-in-part of U.S. patent application Ser. No. 09/798,765 filed on Mar. 2, 2001.

### BACKGROUND OF THE INVENTION

The present invention relates to resilient wheels and brake mechanisms therefor. More particularly, the present invention relates to brake mechanisms adapted for use in connection with resilient wheels having generally concentric inner and outer wheel portions that are connected to one another by resilient members in a manner to permit resilient, shock-absorbing movement between the inner and outer wheel portions.

In general, resilient wheels comprising an inner hub and an outer wheel portion resiliently connected to one another are known in the art. In such resilient wheels, the inner hub and outer wheel portion are typically connected to one another by a plurality of resilient spring members in a manner to permit resilient movement of the outer wheel portion relative to the hub to absorb shock and to displace external loads. Many such resilient wheels were designed in the early 1900's in response to rapid growth of the automobile industry. A primary goal of such designs was to provide a means for absorbing shock and providing a smoother ride, in a time before pneumatic automobile tires were prevalent.

Resilient wheels of this type have not been effectively used in connection with bicycles. This is partly because conventional caliper-style bicycle brake mechanisms are not particularly suited for use with such resilient wheels. In general, conventional caliper-style bicycle brake mechanisms have brake pads that are positioned adjacent the outer rim of the bicycle wheel for frictional engagement therewith. However, the outer wheel rim of a resilient wheel does not have a fixed path of rotation relative to the hub and axle. In general, the inner hub of a resilient wheel is mounted for rotation about the axle. The outer wheel portion is connected to the hub by resilient spring members in a manner to permit resilient movement of the outer wheel portion relative to the hub. This resilient movement of the outer wheel portion allows the outer wheel portion to be displaced relative to the inner hub in response to external loads. Thus, the outer wheel rim of a resilient wheel does not have a fixed path of rotation like the rim of a conventional bicycle wheel with rigid spokes and, consequently, conventional caliper-style bicycle brake mechanisms that engage with the outer wheel rim are not suitable for use with resilient wheels.

Resilient wheels also have not been effectively utilized in connection with motorcycles. Although it is common for motorcycles to comprise front and rear suspension systems, such suspension systems are typically in the form of a front suspension fork and a swing arm or other suspension mechanism connecting the rear wheel to the frame of the motorcycle. The inventors of the present application have determined that the use of resilient wheels of the type discussed above can supplement or eliminate need for such prior art motorcycle suspension systems. Moreover, the inventors have determined a manner of utilizing conventional motorcycle disc brakes in connection with resilient wheels without interfering with the relative movement between the outer rim and inner hub thereof.

### SUMMARY OF THE INVENTION

It is an object of the present invention to provide a brake mechanism suitable for use with resilient wheels. A more specific object of the invention is to provide a brake mechanism adapted for use with a resilient wheel in a manner that permits resilient displacement of an outer wheel portion relative to an inner wheel portion of the resilient wheel. Another object of the invention is to provide a cam action brake mechanism adapted for use with both resilient wheels and conventional wheels.

In one aspect of the invention, a wheel and brake system comprises an inner wheel, an outer wheel and a brake mechanism. The inner wheel is adapted to be rotatably mounted to a vehicle. The outer wheel is positioned generally concentric with the inner wheel. A plurality of resilient members connect the inner and outer wheel to one another in a manner to permit resilient movement of the outer wheel relative to the inner wheel. The brake mechanism comprises a mounting block, a lever arm and a cam follower. The mounting block is adapted to be mounted to the vehicle adjacent the inner wheel. The lever arm is pivotally connected to the mounting block in a manner to permit pivoting movement of the lever arm relative to the mounting block. The lever arm is movable relative to the mounting block between a braking position and a non-braking position. The lever arm includes a cam surface. The cam follower is connected to the mounting block in a manner to permit reciprocating movement of the cam follower relative to the mounting block. The cam follower is movable relative to the mounting block between a wheel-engaging position and a disengaged position. The cam follower has a cam engaging portion that is adapted for camming engagement with the cam surface of the lever arm in a manner so that movement of the lever arm from its non-braking position toward its braking position causes movement of the cam follower from its disengaged position toward its wheel-engaging position. The cam follower has a wheel-engaging portion that is adapted for frictional engagement with the inner wheel when the cam follower is in its wheel-engaging position.

In another aspect of the invention, a wheel and brake system comprises an inner wheel, an outer wheel positioned generally concentric with the inner wheel, a plurality of resilient members connecting the inner and outer wheels to one another for resilient relative movement, and a brake mechanism. The brake mechanism includes a mounting member adapted to be mounted to the vehicle, first and second lever arms, and an actuating member. The first lever arm is pivotally connected to the mounting member in a manner to permit pivoting movement of the first lever arm relative to the mounting member between a braking position and a non-braking position. Similarly, the second lever arm is pivotally connected to the mounting member in a manner to permit pivoting movement of the second lever arm relative to the mounting member between a braking position and a non-braking position. The first lever arm has a first wheel-engaging portion adapted for frictional engagement with a first side of the inner wheel when the first lever arm is in its braking position. Similarly, the second lever arm has a second wheel-engaging portion adapted for frictional engagement with a second side of the inner wheel when the second lever arm is in its braking position. The actuating member is operatively connected to the first and second lever arms in a manner to cause movement of the first and second lever arms from their respective non-braking positions to their respective braking positions.

In another aspect of the invention, a cam action brake mechanism comprises a mounting block, a lever arm and a cam follower. The mounting block is adapted for mounting the brake mechanism to a vehicle. The lever arm is pivotally connected to the mounting block in a manner to permit pivoting movement of the lever arm relative to the mounting block between a braking position and a non-braking position. The lever arm includes a cam surface. The cam follower is connected to the mounting block in a manner to permit reciprocating movement of the cam follower relative to the mounting block between a wheel-engaging position and a disengaged position. The cam follower has a cam engaging portion that is adapted for camming engagement with the cam surface of the lever arm in a manner so that movement of the lever arm from its non-braking position toward its braking position causes movement of the cam follower from its disengaged position toward its wheel-engaging position. The cam follower has a wheel-engaging portion adapted for frictional engagement with a wheel of the vehicle when the brake mechanism is mounted to the vehicle and when the cam follower is in its wheel-engaging position.

In yet another aspect of the invention, a wheel and brake system comprises a wheel axle, an inner hub, an outer hub, a plurality of resilient members, and a brake mechanism. The inner hub is mounted to the wheel axle in a manner allowing rotation of the inner hub relative to the wheel axle about an axis of rotation. The outer wheel is positioned generally concentric to the inner wheel and the plurality of resilient members connect the inner hub to the outer wheel in a manner to permit resilient eccentric movement of the outer wheel relative to the inner hub. The resilient members also connect the inner hub to the outer wheel in a manner so that the outer wheel rotates with the inner hub relative to the wheel axle. The brake mechanism comprises a rotor and a caliper. The rotor is fixed to the inner hub in a manner so that the rotor rotates with the inner hub relative to the wheel axle and the caliper is rotationally fixed relative to the wheel axle and has opposing first and second rotor-engaging surfaces that are movable toward and apart from one another. At least a portion of the rotor is positioned between the first and second rotor-engaging surfaces of the caliper in a manner so that movement of the first and second rotor-engaging surfaces of the caliper toward one another causes the first and second rotor-engaging surfaces of the caliper to engage the rotor and squeeze the rotor therebetween to thereby resist rotation of the inner hub relative to the wheel axle.

In still another aspect of the invention, a front wheel assembly of a two-wheeled vehicle comprises a fork, a wheel axle, an inner hub, an outer wheel, a plurality of resilient members, and a brake mechanism. The fork has first and second fork blades and a connection portion. The fork blades each having upper and lower end margins and the connection portion joins the upper end margin of the first fork blade to the upper end margin of the second fork blade. The wheel axle is fixed to and extends between the lower end margins of the first and second fork blades. The inner hub is mounted to the wheel axle in a manner allowing rotation of the inner hub relative to the wheel axle about an axis of rotation and the outer wheel is positioned generally concentric to the inner wheel. The plurality of resilient members connect the inner hub to the outer wheel in a manner to permit resilient eccentric movement of the outer wheel relative to the inner hub and also connect the inner hub to the outer wheel in a manner so that the outer wheel rotates with the inner hub relative to the wheel axle. The brake mechanism comprises a rotor and a caliper. The rotor is fixed to the inner hub in a manner so that the rotor rotates with the inner hub relative to the wheel axle and the caliper is rotationally fixed relative to the wheel axle and has opposing first and second rotor-engaging surfaces that are movable toward and apart from one another. At least a portion of the rotor is positioned between the first and second rotor-engaging surfaces of the caliper in a manner so that movement of the first and second rotor-engaging surfaces of the caliper toward one another causes the first and second rotor-engaging surfaces of the caliper to engage the rotor and squeeze the rotor therebetween to thereby resist rotation of the inner hub relative to the wheel axle.

While the principal advantages and features of the present invention have been described above, a more complete and thorough understanding and appreciation for the invention may be attained by referring to the drawings and description of the preferred embodiments, which follow.

### BRIEF DESCRIPTION OF THE DRAWINGS

FIG. 1 is a partial side elevational view of a vehicle incorporating the wheel and brake system of the present invention;

FIG. 2 is an enlarged side elevational view of the brake mechanism shown in FIG. 1;

FIG. 3 is a top plan view of the brake mechanism;

FIG. 4 is a perspective view of the mounting block of the brake mechanism;

FIG. 5 is a side elevational view of the mounting block shown in FIG. 4;

FIG. 6 is a top plan view of the lever arm of the brake mechanism;

FIG. 7 is an end elevational view of the lever arm of FIG. 6, showing the camming surface of the lever arm.

FIG. 8 is a partial front elevational view of another embodiment of the wheel and brake system of the present invention; and

FIG. 9 is a partial side elevational view of a vehicle incorporating yet another embodiment of the present invention; and

FIG. 10 is a detail front elevational view of the rotor and caliper assembly of embodiment of the invention shown in FIG. 9, and is shown with portions of the assembly in cross-section for clarity.

Reference characters used in the written specification refer to corresponding parts shown in the drawings.

### DETAILED DESCRIPTION OF THE PREFERRED EMBODIMENTS

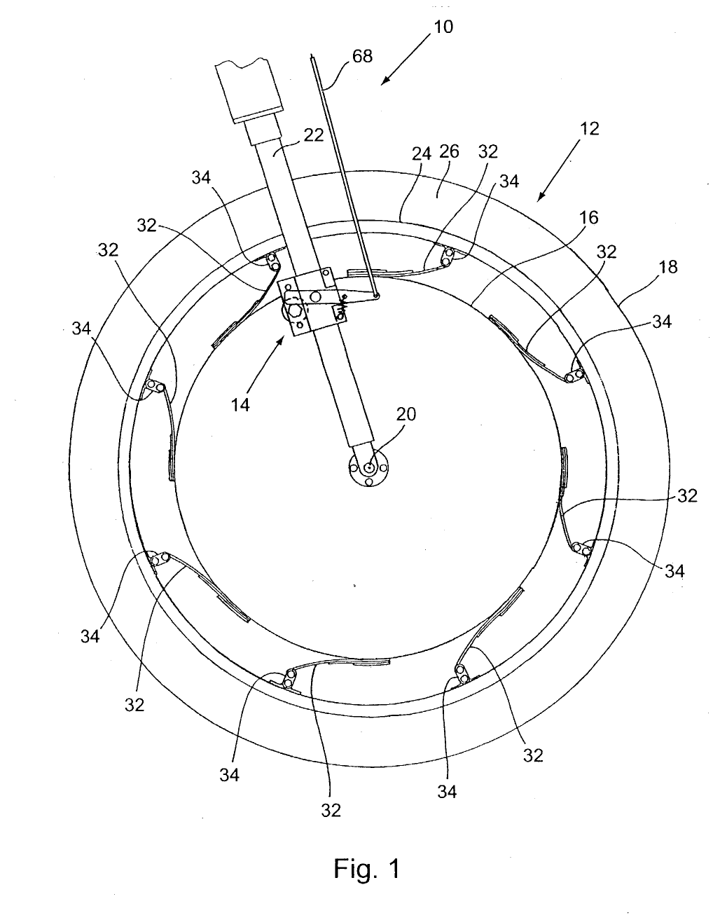

A wheel and brake system of the present invention is represented generally in FIG. 1 by the reference numeral 10. The system comprises a resilient wheel, represented generally by the reference numeral 12, and a brake mechanism, represented generally by the reference numeral 14.

With continued reference to FIG. 1, the resilient wheel 12 comprises an inner wheel (or hub) 16 and an outer wheel 18. The inner wheel 16 is rotatably mounted to a vehicle axle 20, which is supported from the vehicle by support arms (or forks) 22. The outer wheel 18 surrounds the inner wheel 16 and is generally concentric with the inner wheel 16 when the resilient wheel 12 is at equilibrium, as described below. Preferably, the outer wheel 18 has an outer peripheral portion 24 adapted to support a tire 26. For optimal traction, shock absorption and overall performance, the tire 26 is a preferably a pneumatic tire, although other types of tires (e.g., solid rubber) could be used without departing from the scope of the present invention. Alternatively, the outer peripheral portion 24 of the outer wheel 18 could be configured for direct ground engagement (i.e. with no tire at all) without departing from the scope of the present invention.

A plurality of resilient members 32 connect the outer wheel 18 to the inner wheel 16. As shown in FIG. 1, the resilient members 32 are preferably spaced generally circumferentially about the inner and outer wheels. Preferably, the resilient members 32 comprise resilient leaf springs that are adapted to deform elastically in response to external forces and to return to equilibrium positions when the external forces are removed. However, other types of resilient members (e.g., coil springs) that are adapted to elastically deform in response to external forces could be used without departing from the scope of the present invention.

The resilient leaf springs 32 connect the inner and outer wheels 16 and 18 in a manner to efficiently transfer rotational motion between the inner and outer wheels 16 and 18. Thus, the inner and outer wheels 16 and 18 both rotate about the axle 20 together as a unit. The leaf springs 32 also permit resilient movement of the outer wheel 18 relative to the inner wheel 16 in response to external forces applied to the outer wheel 18. In operation, when the outer wheel 18 encounters an external force (e.g., bumps, pot holes, etc.), the resilient leaf springs 32 flex in a manner to permit movement of the outer wheel 18 relative to the inner wheel 18 to absorb the shock. Thus, the path of rotation of the outer wheel 18 is generally concentric with the inner wheel 16 and axle 20 when the wheel 12 is in an equilibrium condition, but the path of rotation of the outer wheel 18 is eccentric relative to the inner wheel 16 and axle 20, at least momentarily, when the outer wheel 18 moves in response to an external force. Due to the resiliency of the leaf springs 32 (more particularly, the restoring forces stored in the leaf springs 32 due to their temporary elastic deformation), the outer wheel 18 is re-centered after the external force is removed, and the paths of rotation of the inner and outer wheels 16 and 18 are then generally concentric again. Depending on the spring constants of the leaf springs 32, the outer wheel 18 may be slightly off center relative to the inner wheel 16, even when at rest, due to the weight of the vehicle itself.

Preferably, at least one end of each of the leaf springs 32 is pivotally connected to one of the inner and outer wheels 16 and 18. As shown in FIG. 1, each of the leaf springs 32 is pivotally connected to the outer wheel 18 by pivot links 34, and the opposite end of each of the leaf springs 32 is fixedly connected to the inner wheel 16 with a mechanical fastener such as a rivet. Alternatively, the leaf springs 32 could be pivotally connected to the inner wheel 16, or to both the inner and outer wheels 16 and 18, without departing from the scope of the present invention. This freedom of action is important because it reduces the likelihood that the leaf springs 32 will be bent or broken under strain at the points of connection.

Thus, when an external load is applied generally inwardly against one portion of the outer wheel 18, the leaf springs 32 closest to where the force is applied will be compressed or flattened to permit the inner and outer wheels 16 and 18 to move closer to one another, and the leaf springs 32 at the opposite end of the wheel (i.e., 180 degrees from the location of the external force) will be drawn away in tension from the inner and outer wheels 16 and 18 to permit the inner and outer wheels to move away from one another at that location. The pivot links 34 facilitate this movement of the leaf springs 32. The leaf springs 32 at the sides (i.e., 90 degrees and 270 degrees from the location of the external force) will not be in substantial compression or tension, but the points of connection will be subjected to shear forces. The pivot links help to accommodate such shear forces by allowing some limited relative movement between the inner and outer wheels 16 and 18 without putting excessive strain on the leaf springs 32.

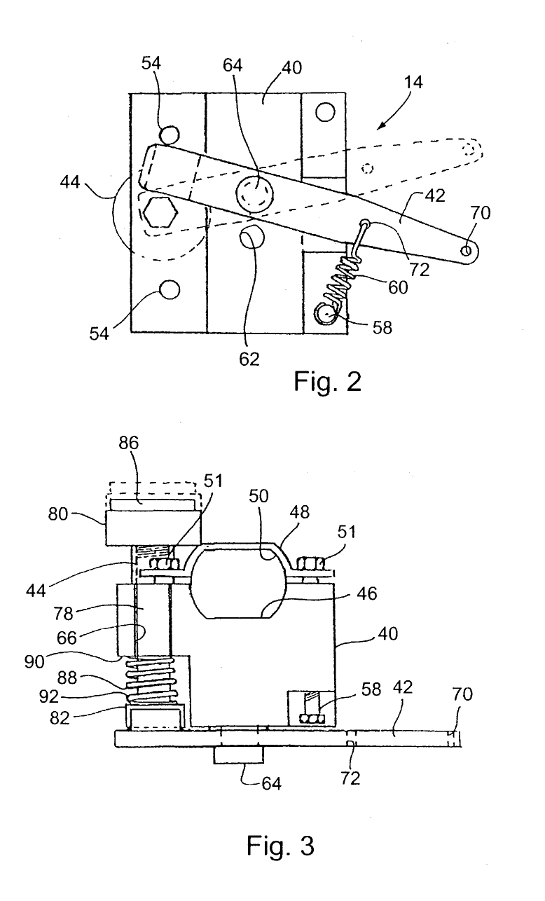

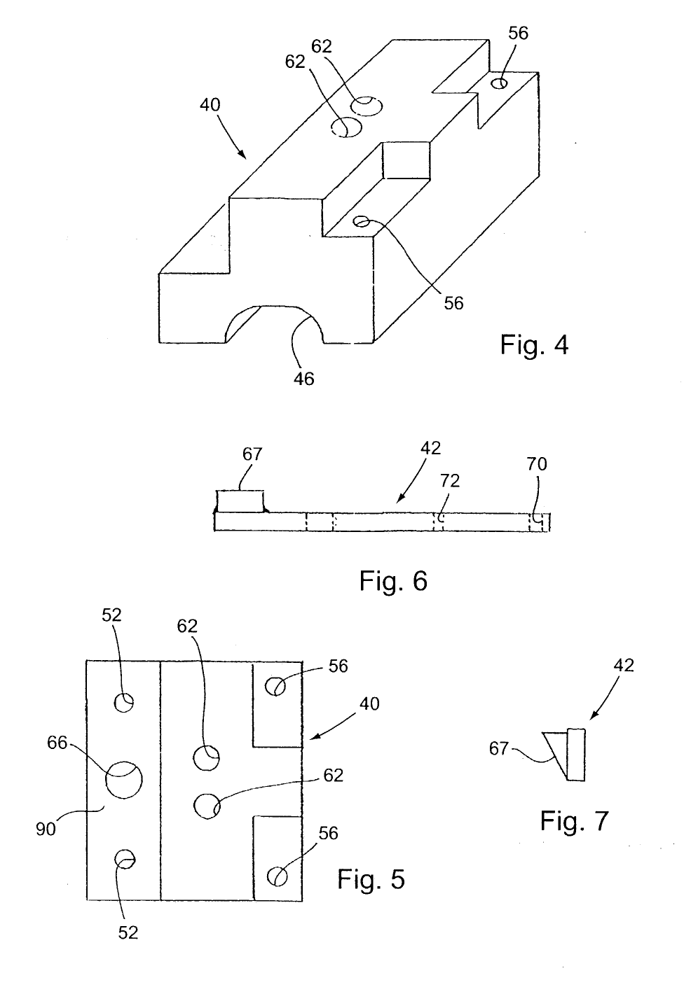

As best shown in FIGS. 2 and 3, the brake mechanism 14 comprises a mounting block 40, a lever arm 42 and a cam follower 44. The mounting block 40 is adapted to be mounted to one of the vehicle's support arms (or forks) 22 adjacent the inner wheel 16 (see FIG. 1). As shown in FIGS. 3 and 4, an inner portion of the mounting block 40 includes a recess 46 sized and configured to receive a portion of the support arm 22 to which it is mounted. A mounting bracket 48 fits around the opposite side of the support arm 22 to hold the mounting block 40 securely on the support arm 22. The bracket 48 includes a similar recess 50 to accommodate a portion of the support arm 22 to which the mounting block 40 is secured. The mounting bracket 48 and mounting block 40 are connected to one another with mechanical fasteners 51, which allow for efficient installation and adjustment of the mounting block 40.

Details of the mounting block 40 itself are shown in FIGS. 4 and 5. The mounting block 40 includes small bores 52 adapted to receive small roll pins 54 (see FIG. 2) for limiting the extent of the movement of the lever arm 42, as described below. Another set of small bores 56 are each sized to receive a small bolt 58, which is adapted to support a small tension spring 60 for returning the lever arm 42 to a starting position, as described below. The mounting block 40 also includes two pivot bores 62, each of which is adapted to receive a pivot pin 64 for pivoting the lever arm 42 relative to the mounting block 40. In addition, the mounting block 40 includes a larger transverse bore 66 for receiving the cam follower 44 in a manner to permit reciprocating movement of the cam follower 44 therein relative to the mounting block 40.

It should be noted that in FIG. 2, only one of the pivot bores 62 is needed and, similarly, only one of the tension spring supporting bolts 58 is needed. However, the same mounting block 40 can be used on the opposite support arm (not shown), albeit inverted, where the other pivot bore 62 and tension spring supporting bolt 58 will be used. Thus, a single casting can be used for both mounting blocks.

As discussed above, the lever arm 42 is pivotally connected to the mounting block 40 by the pivot pin 64 in a manner to permit pivoting movement of the lever arm 42 relative to the mounting block 40. The lever arm 42 is movable relative to the mounting block 40 between a braking position (shown in phantom lines in FIG. 2) and a non-braking position (shown in solid lines in FIG. 2). As best shown in FIG. 7, one end of the lever arm 42 includes a cam surface 67. Preferably, the cam surface 67 is an inclined surface that is generally linear. However, the cam surface 67 could also be an arcuate, or partially arcuate surface without departing from the scope of the invention. An opposite end of the lever arm 42 includes a small aperture 70 adapted for connection to a brake cable 68 (see FIG. 1) for actuating the lever arm 42. Another small aperture 72, located between the pivot pin 64 and the brake cable aperture 70, is adapted for connecting the tension spring 60 to the lever arm 42. As described above, and as shown in FIG. 2, the other end of the tension spring 60 is connected to the bolt 58 extending from the mounting block 40. The tension spring 60 is adapted to return the lever arm 42 to its non-braking position (shown in solid lines in FIG. 2).

As best shown in FIG. 3, the cam follower 44 is connected to the mounting block 40 in a manner to permit reciprocating movement of the cam follower 44 relative to the mounting block 40. The transverse bore 66 is sized to receive a cylindrical body portion 78 of the cam follower 44 for reciprocating movement therein. The cam follower 44 includes a wheel-engaging portion 80 on one end of the cylindrical body portion 78 and a cam-engaging portion 82 on the opposite end of the cylindrical body portion 78. As shown in FIG. 3, the cam follower 44 is movable relative to the mounting block 40 between a wheel-engaging position (shown in phantom lines in FIG. 3) and a disengaged position (shown in solid lines in FIG. 3). The cam-engaging portion 82 of the cam follower 44 is adapted for camming engagement with the cam surface 67 of the lever arm 42 in a manner so that movement of the lever arm 42 from its non-braking position (shown in solid lines in FIG. 2) toward its braking position (shown in phantom lines in FIG. 2) causes movement of the cam follower 44 from its disengaged position (shown in solid lines in FIG. 3) toward its wheel-engaging position (shown in phantom lines in FIG. 3). The wheel-engaging portion 80 of the cam follower 44 includes a brake pad 86, preferably of an elastomeric material such as hard rubber, which is adapted for frictional engagement with the inner wheel 16 when the cam follower 44 is in its wheel-engaging position.

As shown in FIG. 3, a return spring 88 is positioned between cam follower 44 and the mounting block 40. Preferably, one end of the return spring 88 is in abutting engagement with a recessed surface 90 of the mounting block 40 and an opposite end of the return spring 88 is in abutting engagement with an annular shoulder portion 92 of the cam-engaging portion 82 of the cam follower 44. Preferably, the return spring 88 is a compression spring that biases the cam follower 44 toward its disengaged position (shown in solid lines in FIG. 3). Alternatively, the return spring could be a tension spring connected between the mounting block and the wheel-engaging portion 80 of the cam follower 44 without departing from the scope of the invention.

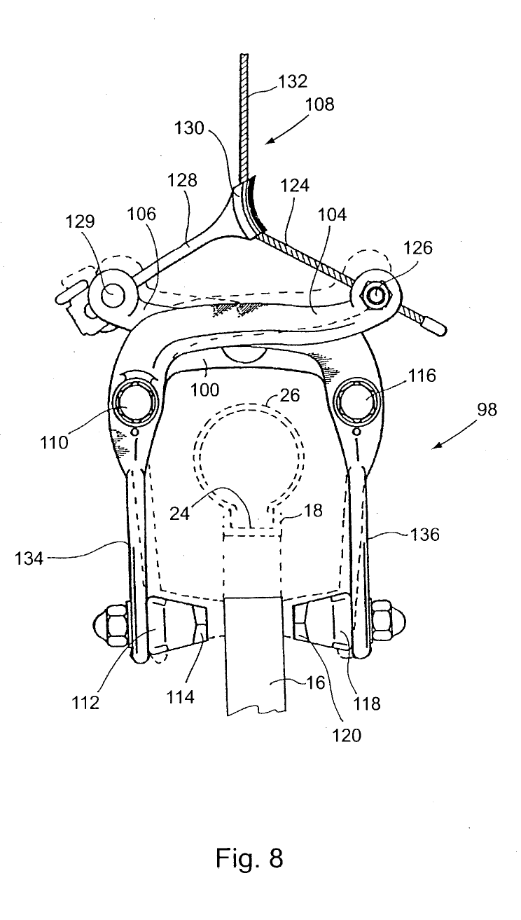

FIG. 8 is a partial front elevational view of a vehicle incorporating a another embodiment of a wheel and brake system of the present invention. The brake mechanism, shown generally as 98, is adapted for use in connection with a resilient wheel 12 of the type described above. In general, the brake mechanism 98 comprises a mounting member 100 adapted to be mounted to the vehicle (not shown), a first lever arm 104, a second lever arm 106 and an actuating member 108. As shown in FIG. 8, the mounting member 100 is preferably mounted to the vehicle at a location radially outwardly from the outer wheel 18.

The first lever arm 104 is pivotally connected to the mounting member 100 by a pivot pin 110 in a manner to permit pivoting movement of the first lever arm 104 relative to the mounting member between a braking position (shown in phantom lines in FIG. 8) and a non-braking position (shown in solid lines in FIG. 8). The first lever arm 104 has a first wheel-engaging portion 112 at one end. The first wheel-engaging portion 112 includes a brake pad 114, preferably of an elastomeric material such as hard rubber, which is adapted for frictional engagement with a first side of the inner wheel 16 when the first lever arm 104 is in its braking position.

Similarly, the second lever arm 106 is pivotally connected to the mounting member 100 by a pivot pin 116 in a manner to permit pivoting movement of the second lever arm 106 relative to the mounting member between a braking position (shown in phantom lines in FIG. 8) and a non-braking position (shown in solid lines in FIG. 8). The second lever arm 106 has a second wheel-engaging portion 118 at one end. The second wheel-engaging portion 118 also includes a brake pad 120, which is preferably of an elastomeric material such as hard rubber. Like the brake pad 114 of the first wheel-engaging portion 112 of the first lever arm 104, the brake pad 120 is adapted for frictional engagement with a second side of the inner wheel 16 when the second lever arm 106 is in its braking position.

As shown in FIG. 8, the actuating member 108 preferably comprises a brake cable 124, which is operatively connected to both of the first and second lever arms 104 and 106 in a manner to cause movement of the first and second lever arms 104 and 106 from their respective non-braking positions (shown in solid lines in FIG. 8) toward their respective braking positions (shown in phantom lines in FIG. 8). As shown in FIG. 8, a lower end of the brake cable 124 is connected to the first lever arm 104 with a mechanical fastener 126. A cable retainer 128 extends from the second lever arm 106 to the brake cable 124. A proximal end of the cable retainer 128 is connected to the second lever arm 106 by a mechanical fastener 129. A distal end of the cable retainer 128 includes a grip 130 configured to securely retain a portion of the brake cable 124. Thus, an upper end 132 of the brake cable is operatively connected to both the first lever arm 104 and the second lever arm 106 so that upward movement of the upper end 132 of the brake cable causes the first and second lever arms 104 and 106 to move from their respective non-braking positions (shown in solid lines in FIG. 8) toward their respective braking positions (shown in phantom lines in FIG. 8).

Thus far, the brake mechanism 98 described is similar in most respects to a conventional center-pull type caliper brake for bicycles. However, the brake mechanism 98 is adapted for use with the resilient wheel 12 of the invention. As shown in FIG. 8, extended portions 134 and 136 of the first and second lever arms 104 and 106 extend radially inwardly from the mounting member 100 toward the inner wheel 16. The extended portions 134 and 136 are spaced from the outer wheel 18 throughout the entire range of motion of the first and second lever arms 104 and 106 so as not to interfere with the rotational movement of the outer wheel or radial movement of the outer wheel 18 relative to the inner wheel 16. Also, it should be understood that, although the brake mechanism 98 shown in FIG. 8 and described above is similar to a conventional center-pull type caliper brake, a side-pull type caliper brake configuration could also be employed without departing from the scope of the invention.

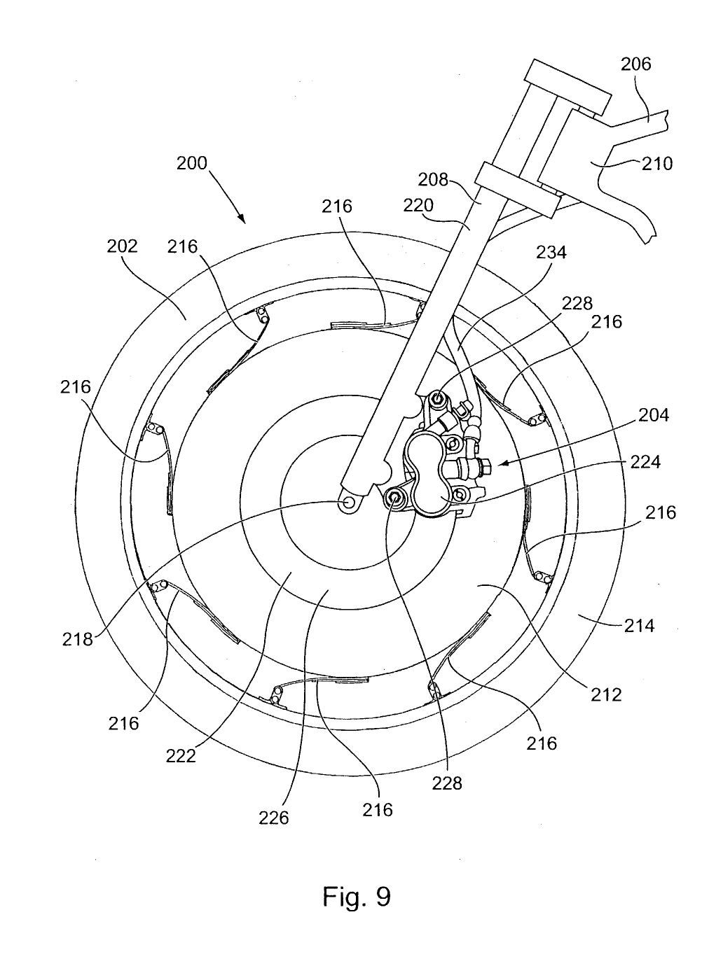

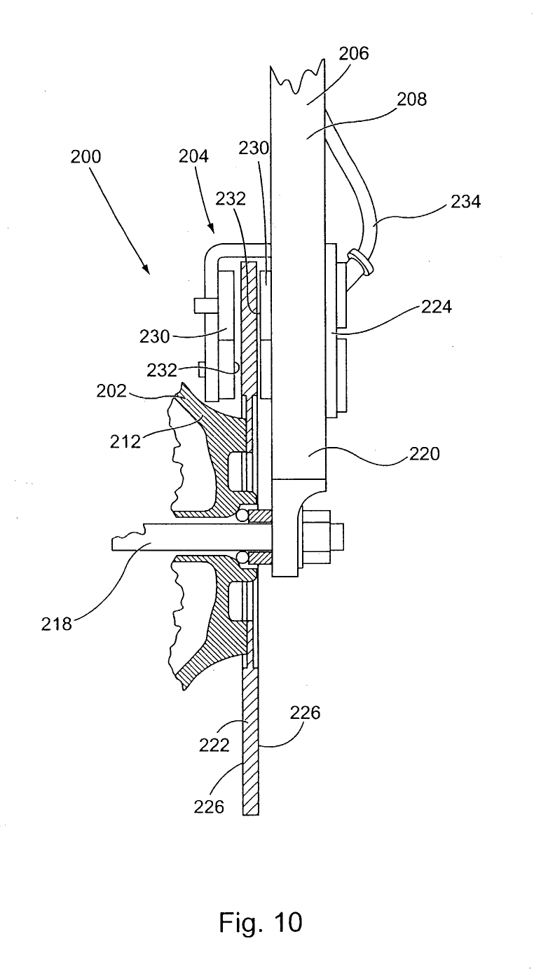

Yet another embodiment of a wheel and brake system in accordance with the invention is shown in FIGS. 9 and 10. This wheel and brake system 200 is particularly suited for use in connection with motorcycles, but could also be used in connection with other types of vehicles. In general, the wheel and brake system 200 comprises a resilient wheel 202 and a brake mechanism 204 that are preferably connected to a motorcycle 206 by a front fork 208 which is pivotally attached to the frame 210 of the motorcycle. Additionally, the wheel and brake system 200 can be utilized on the rear wheel of a motorcycle by mounting it directly to the frame 210 of the motorcycle 206.

A resilient wheel 202 of this embodiment is similar to the resilient wheel utilized in the alternative embodiments initially discussed and, like such other embodiments, comprises an inner wheel (or hub) 212 connected to an outer wheel 214 by a plurality of resilient members 216 in the manner previously described. As shown in FIGS. 9 and 10, the inner wheel 212 is rotationally mounted on the front wheel axle 218 which spans between the fork blades 220 of the motorcycle's front fork 208.

The brake mechanism 204 differs from those of the previous embodiments described above and is preferably a standard motorcycle or bicycle disk brake. Such types of disk brakes are well known in the vehicle industry and can be mechanically actuated, as is the disk brake disclosed in U.S. Pat. No. 4,633,978 which is hereby incorporated by reference. Alternatively such disk brakes can be hydraulically actuated, as is the disk brake disclosed in U.S. Pat. No. 3,997,032 which is also hereby incorporated by reference. Thus, it should be appreciated that a detailed discussion of the disk brake components and their operation is not necessary to understand and appreciate the invention. Nonetheless, a brief discussion of the main components of the brake mechanism 204 shown in FIGS. 9 and 10 and its operation follows.

The brake mechanism 204 generally comprises a rotor 222 and a caliper 224. The rotor 222 or disk is preferably formed of metal and preferably has an annular disk shape with opposite parallel surfaces 226. The rotor 222 is preferably fixed to one side of the inner hub 212 of the resilient wheel 202 in a manner such that it rotates with the resilient wheel about the wheel axle 218. The caliper 224 is preferably fixed to and supported by one of the fork blades 220 of the motorcycle 206 by a pair of bolts 228. Thus, the caliper is rotationally fixed relative to the wheel axle 218 and the fork 208, meaning that it remains in a constant rotational orientation relative thereto. The caliper is preferably equipped with a pair of replaceable brake pads 230 as shown in FIG. 10. Opposing surfaces 232 of the brake pads 230 form rotor-engaging surfaces of the caliper 224 and are positioned by the caliper in a manner such that a portion of the rotor 222 is positioned therebetween. A hydraulic actuation system 234 is attached to the caliper 224 and is configured to pressurize hydraulic fluid within the caliper in response to a desire to apply brakes to the resilient wheel 202.

In operation, the opposing surfaces 232 of the disk pad are held spaced from the rotor 222 by the caliper 224 when the brakes are not being applied. In this position, the rotor 222 rotates with the inner hub of the resilient wheel about the wheel axle 218 without resistance from the caliper 224. However, when desired, the hydraulic actuation system 234 pressurizes the hydraulic fluid within the caliper 224 which, in response, causes the caliper to force the opposing surfaces 232 of the brake pads 230 toward one another. As the opposing surfaces 232 of the brake pads 230 move toward one another, they eventually engage and squeeze the rotor surfaces 226 passing therebetween. This squeezing resists the rotation of rotor 222 relative to the caliper 224 and thereby resists the rotation of the resilient wheel 202 relative to the wheel axle 218. When the hydraulic actuation system 232 releases the hydraulic pressure within the caliper 224, friction between the brake pads 230 and the rotor 222 causes the brake pads to move away from one another and to thereby disengage with the rotor surfaces 226 to again allow free rotation of the resilient wheel 202 about the wheel axle 218.

In view of the above, it can be seen that the present invention overcomes problems associated with the prior art and achieves other advantageous results. As various changes could be made without departing from the scope of the invention, it is intended that all matter contained in the above description and shown in the accompanying drawings be interpreted as illustrative and not limiting. It should be understood that other configurations of the present invention could be constructed, and different uses could be made, without departing from the scope of the invention as set forth in the following claims.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Similarly, to the extent the term “portion” is used in the claims or is added by amendment, such term should be construed as meaning some or all of the item or element that it qualifies.

What is claimed is:

1. A wheel and brake system comprising:
a wheel axle;
an inner hub mounted to the wheel axle in a manner allowing rotation of the inner hub relative to the wheel axle about an axis of rotation;
an outer wheel positioned generally concentric to the inner wheel;
a plurality of resilient members connecting the inner hub to the outer wheel in a manner to permit resilient eccentric movement of the outer wheel relative to the inner hub, the resilient members also connecting the inner hub to the outer wheel in a manner so that the outer wheel rotates with the inner hub relative to the wheel axle; and
a brake mechanism comprising a rotor and a caliper, the rotor being fixed to the inner hub in a manner so that the rotor rotates with the inner hub relative to the wheel axle, the caliper being rotationally fixed relative to the wheel axle and having opposing first and second rotor-engaging surfaces that are movable toward and apart from one another, at least a portion of the rotor being positioned between the first and second rotor-engaging surfaces of the caliper in a manner so that movement of the first and second rotor-engaging surfaces of the caliper toward one another causes the first and second rotor-engaging surfaces of the caliper to engage the rotor and squeeze the rotor therebetween to thereby resist rotation of the inner hub relative to the wheel axle.

2. A two-wheeled vehicle comprising a wheel and brake system in accordance with claim 1.

3. A two-wheeled vehicle in accordance with claim 2 wherein the vehicle further comprises a front fork and a frame, the front fork being pivotally connected to the frame and being rigidly connected to the wheel axle, the caliper being supported by the fork.

4. A wheel and brake system in accordance with claim 1 wherein the wheel and brake system further comprises a hydraulic actuation system, the hydraulic actuation system being operatively connected to the caliper in a manner so that, when actuated, the hydraulic actuation system forces the first and second rotor-engaging surfaces of the caliper toward one another.

5. A wheel and brake system in accordance with claim 1 wherein the rotor comprises opposite first and second parallel planar surfaces and wherein the first and second rotor-engaging surfaces of the caliper are generally parallel planar surfaces.

6. A wheel and brake system in accordance with claim 5 wherein the caliper comprises first and second removable disk pads, one of the first and second rotor-engaging surfaces of the caliper being a surface of the first disk pad and the other of the first and second rotor-engaging surfaces being a surface of the second disk pad.

7. A front wheel assembly of a two-wheeled vehicle comprising:
a fork having first and second fork blades and a connection portion, the fork blades each having upper and lower end margins, the connection portion joining the upper end margin of the first fork blade to the upper end margin of the second fork blade;
a wheel axle fixed to and extending between the lower end margins of the first and second fork blades;
an inner hub mounted to the wheel axle in a manner allowing rotation of the inner hub relative to the wheel axle about an axis of rotation;
an outer wheel positioned generally concentric to the inner wheel;
a plurality of resilient members connecting the inner hub to the outer wheel in a manner to permit resilient eccentric movement of the outer wheel relative to the inner hub, the resilient members also connecting the inner hub to the outer wheel in a manner so that the outer wheel rotates with the inner hub relative to the wheel axle; and
a brake mechanism comprising a rotor and a caliper, the rotor being fixed to the inner hub in a manner so that the rotor rotates with the inner hub relative to the wheel axle, the caliper being rotationally fixed relative to the wheel axle and having opposing first and second rotor-engaging surfaces that are movable toward and apart from one another, at least a portion of the rotor being positioned between the first and second rotor-engaging surfaces of the caliper in a manner so that movement of the first and second rotor-engaging surfaces of the caliper toward one another causes the first and second rotor-engaging surfaces of the caliper to engage the rotor and squeeze the rotor therebetween to thereby resist rotation of the inner hub relative to the wheel axle.

8. A front wheel assembly in accordance with claim 7 wherein the wheel and brake system further comprises a hydraulic actuation system, the hydraulic actuation system being operatively connected to the caliper in a manner so that, when actuated, the hydraulic actuation system forces the first and second rotor-engaging surfaces of the caliper toward one another.

9. A front wheel assembly in accordance with claim 7 wherein the rotor comprises opposite first and second parallel planar surfaces and wherein the first and second rotor-engaging surfaces of the caliper are generally parallel planar surfaces.

10. A front wheel assembly in accordance with claim 9 wherein the caliper comprises first and second removable disk pads, one of the first and second rotor-engaging surfaces of the caliper being a surface of the first disk pad and the other of the first and second rotor-engaging surfaces being a surface of the second disk pad.
